(19) United States
(12) Patent Application Publication
(10) Pub. No.: US 2004/0194059 A1
(43) Pub. Date: Sep. 30, 2004

(54) Method to deploy software using an open service gateway initiative (OSGi) framework

(75) Inventors: Raji Lakshmi Akella, Austin, TX (US); Scott James Bennett, Round Rock, TX (US); Richard T. Slade, Austin, TX (US)

Correspondence Address: Greg Goshorn, P.C., Attn: Greg Goshorn, Suite 115-119, 2110 W. Slaughter Lane, Austin, TX, 78748, US

(73) Assignee: INTERNATIONAL BUSINESS MACHINES CORPORATION, Armonk, NY (US)

(21) Appl. No.: 10/401,328

(22) Filed: Mar. 27, 2003

(51) Int. Cl. G06F 9/44

(52) U.S. Cl. 717/118; 717/116

(57) ABSTRACT

Provided is an OSGiInstallBundle class that enables non-OSGi compliant resources, either Java, native code or some other format, to be downloaded from a server and installed on a client system running an OSGi framework. The OSGiInstallBundle class can be executed by a user or another bundle. The OSGiInstallBundle class manages non-OSGi resources by registering with the OSGi framework and evoking a start method. The start method extracts resources from, for example but not limited to, a Java archive, or JAR, file. In one embodiment, the registration of the class and information about the extracted files is broadcast to other installed OSGi bundles so that other OSGi bundles are aware of the newly installed bundle and its resources. In another embodiment, OSGi bundles may register a OSGIInstallBundle “listener” with the framework so that only those bundles that request notification of the installation of the non-OSGI bundle receive the notification.

### TECHNICAL FIELD

The present invention relates to method of deploying a non-OSGi bundle in a OSGi framework.

### BACKGROUND OF THE INVENTION

In 1999, the Open Services Gateway Initiative (OSGi) was initiated to develop an open specification for the delivery of services over local networks and devices. Currently, OSGi standard is supported by over eighty (80) companies. OSGi was developed to provide services to environments such as homes, cars and offices. Devices that employ the OSGi specification include, but are not limited to, television set top boxes, service gateways, cable modems, consumer electronic devices, personal computers (PCs), industrial computers and automobiles. A specification, entitled “The OSGi Services Platform, Release 2,” was published in October 2001

The OSGi environment is organized around a “framework” and “bundles.”The OSGi framework provides an execution environment for electronically downloadable services, or bundles. The framework includes a Java runtime engine, life cycle management, data storage, version management and a service registry. Bundles are Java applications, including classes, methods and other resources, which provide functions, or “services,” to end-users of a computing system and to other bundles. Typically, bundles are stored in a standard Zip-based Java file format, or Java Archive (JAR) file.

Currently, the OSGi environment does not support non-OSGi resources, i.e. resources such as text files and native executables that are not setup or stored in an OSGi complaint manner. As a result, users in an OSGi compliant framework are not able to utilize non-OSGi compliant resources, including most legacy resources.

### SUMMARY OF THE INVENTION

Currently, there is no provision within an OSGi compliant framework for the deployment of non-OSGi compliant services or resources. Typically, an OSGi compliant framework downloads software bundles, or OSGi aware Java applications, from a server system to a client system running the OSGi framework. Each downloaded, OSGi bundle and its resources are registered in the OSGi framework and thereby made available to users and other registered OSGi bundles. In the claimed subject matter, a Java OSGiInstallBundle class enables non-OSGi compliant software bundles, either Java, native code or some other format, to be downloaded from the server system and installed on the client system. The OSGiInstallBundle class can be executed by a user or an OSGi compliant bundle.

The OSGiInstallBundle class manages non-OSGi resources by registering with the OSGi framework and evoking a start method. The start method extracts resources from, for example but not limited to, a Java archive, or JAR, file. In one embodiment, the registration of the class and information about the extracted files is broadcast to other installed OSGi bundles so that other OSGi bundles are aware of the newly installed bundle and its resources. In another embodiment, OSGi bundles may register a OSGIInstallBundle “listener” with the framework so that only those bundles that request notification of the installation of the non-OSGI bundle receive the notification

For example, a generic, non-OSGi bundle, containing a native calculator program, is downloaded to the client system by a special OSGi bundle, which includes the OSGiInstallBundle class; and, if necessary, the calculator program is invoked. Another example is the downloading of a text or help document to the client system by the special OSGi bundle. Once programs or text are downloaded, the bundle may notify other OSGi bundles of the availability of the downloaded resources. Thus, an OSGi framework on the client system can manage a non-OSGi compliant resources, expanding the capability of an OSGi compliant framework and the OSGi specification.

### BRIEF DESCRIPTION OF THE DRAWINGS

A better understanding of the present invention can be obtained when the following detailed description of the disclosed embodiments is considered in conjunction with the following drawings, in which:

FIG. 1 is a block diagram of a computing system that supports a modified Open Services Gateway Initiative (OSGi) architecture, including the claimed subject matter;

FIG. 2 is a block diagram of a Java class that implements the claimed subject matter;

FIG. 3 is a flow chart of a Start method in the Java class of FIG. 2;

FIG. 4 is a flow chart of a Extract Archive method in the Java class of FIG. 2; and

FIG. 5 is a flow chart of a Stop method in the Java class of FIG. 2

### DETAILED DESCRIPTION OF THE DRAWINGS

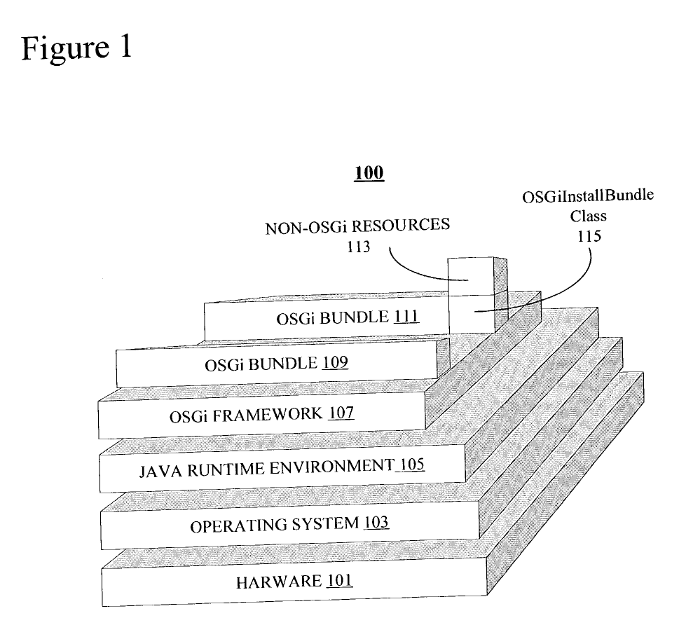

Although described with particular reference to the Open Services Gateway Initiative (OSGi) architecture, the class encapsulating technique of the claimed subject matter is applicable to any standardized architecture in which it may be necessary to incorporate non-standard classes and methods. FIG. 1 illustrates one exemplary architecture in which the system according to the present invention can be implemented, specifically the OSGi platform. Those with skill in the computing arts will recognize that the disclosed embodiments have relevance to a wide variety of architectures and standards in addition to those described below. The software associated with the claimed technique can be stored in a memory and executed by a suitable instruction execution system such as a microprocessor.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared of semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

FIG. 1 is a block diagram of a computing system 100 that supports the claimed extension to the OSGi architecture. The system 100 is implemented on a hardware platform 101, which can include, but is not limited to, such computing platforms as television set top boxes, service gateways, cable modems, consumer electronic devices, personal computers (PCs), industrial computers and automobiles. An operating system (OS) 103 manages the hardware's 101 resources. Examples of three OSs that support the claimed subject matter include Linux, MacIntosh and the various versions of Windows, all of which, as well as others, should be familiar to those with skill in the computing arts. In this example, OS 103 is supporting a Java runtime environment 105. The Java runtime environment 105 supports the Java programming language, which is a product of Sun Microsystems, Inc. of Santa Clara, Calif. Java runtime environment 105 includes a Java runtime engine (not shown) which executes Java programs, Java programs are compiled into byte codes which are interpreted by the Java runtime environment 105 rather then being compiled into native machine code. In this manner, a particular Java program can be written to execute on any hardware platform 101 and OS 103 that includes the Java runtime environment 105.

An OSGi framework 107 is designed to operate in the Java runtime environment 105. Framework 107 provides the core of the OSGi Service Platform Specification. As explained above in the Background, the OSGi Service Platform Specification was first developed in 1999 to simplify the delivery of services over local networks and devices, industrial computers and automobiles. OSGi framework 107 provides an execution environment for electronically downloadable services, or bundles 109 and 111. Framework 107 includes program life cycle management, data storage, program version management and a service registry for bundles 109 and 111. In this example, bundles 109 and 111 are Java applications, including classes, methods and other resources, which provide functions, or “services,” to end-users of computing system 100 and other bundles. Typically, but not necessarily, bundles 109 and 111 are stored in a standard Zip-based Java file format, or Java Archive (JAR) file.

OSGi bundles 109 and 111 include Java classes and other resources which provide functions to end users of system 100 and provide components, or “services,” to other bundles. Bundles typically implement zero or more services. Bundle 109 and 111 can include such things as class files for the Java programming language as well as other data such as, but not limited to, hypertext markup language (HTML) files, help files and icons. Like other OSGI compliant bundles, bundles 109 and 111 each include a manifest file (not shown), which describes the contents of the corresponding bundle 109 or 111 and provides information that the framework 107 requires to correctly install and activate the corresponding bundle 109 or 111. Bundles 109 and 111 include a special class, or “bundle activator,” that provides methods to start and stop the bundle 109 or 111. In addition, bundles 109 and 111 include information, in the manifest file, about any resource dependencies the corresponding bundle 109 or 111 may have.

Unlike bundles 109, bundle 111 includes a OSGiInstallBundle class 115, which enables bundle 111 to download non-OSGi compliant resources 113. Rather than being formatted as a JAR file, resources 113 may, in addition to other possibilities, be formatted in a zip format or may be formatted as simple flat, or text, files.

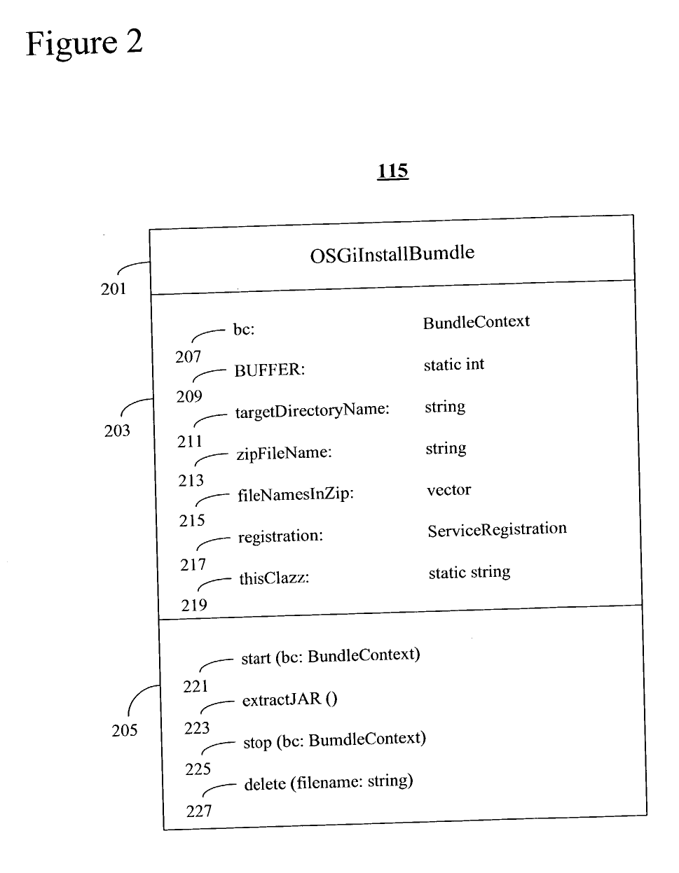

FIG. 2 is a block diagram of OSGiInstallBundle class 115 (FIG. 1) that implements the claimed subject matter. A first section 201 of block, or class, diagram 115 defines the name of class 115, or “OSGiInstallBundle.” A second section 203 of class diagram 115 defines attributes of OSGiInstallBundle class 115. In this example, class 115 includes a “bc” variable 207, “a “BUFFER” variable 209, a “targetDirectoryName” variable 211, a “zipFileName” variable 213, a “fileNamesIn Zip” variable 215, a “registration” variable 217, and a “thisClazz” variable 219. In this example, class 115 is included in bundle 111 (FIG. 1).

Bc variable 207 is a variable of type “BundleContext,” which in the OSGi framework 107 (FIG. 1) contains the attributes and methods to enable an instance of the variable to (1) subscribe to events published by the framework; (2) register services in a OSGi service registry; (3) retrieve service references from the OSGi service registry; (4) get and release service objects for a referenced service; (5) install new bundles such as bundles 109 (FIG. 1) and 111 in the framework; (6) get a list of bundles installed in the framework; (7) get the bundle object for a bundle; and (8) create files in a persistent storage area (not shown), e.g a hard disk drive of the hardware 101 (FIG. 1), provided for the bundle by the framework 107. In other words, an object of type BundleContext is a particular bundle's execution context within the framework 107 and is used to grant access to methods that enable the bundle to interact with the framework 107.

BUFFER variable 209 is a static integer, which defines a block size of a basic data storage area. In other words, BUFFER variable 209 sets the size of the memory chunks allocated and released by the methods of the class 115. TargetDirectoryName variable 211 is a text string that stores a name of a target directory in which class 115 store files. ZipFileName variable 213 is a text string stores names of particular files to store in the directory referenced by targetDirectoryName variable 211. FileNamesInZip variable 215 is a vector, or array of zipFileName objects 213, which can expand to include new objects.

Registration variable 217 is a variable of type “ServiceRegistration,” which in the OSGi framework 107 is a handle for a particular service. The OSGi framework 107 returns a variable of this type when the registration of a particular bundle, e.g. bundle 111, is successful. Bundle's 111 ServiceRegistration variable 217 is not shared with other bundles and is used by the bundle to update the bundle's 111 properties or to unregister bundle 111 from the framework 107. ThisClazz variable 219 is a text string that stores a fully qualified name of class 115, or in this example “OSGIInstallBumdle,” including a directory path to the directory in which class 115 is stored.

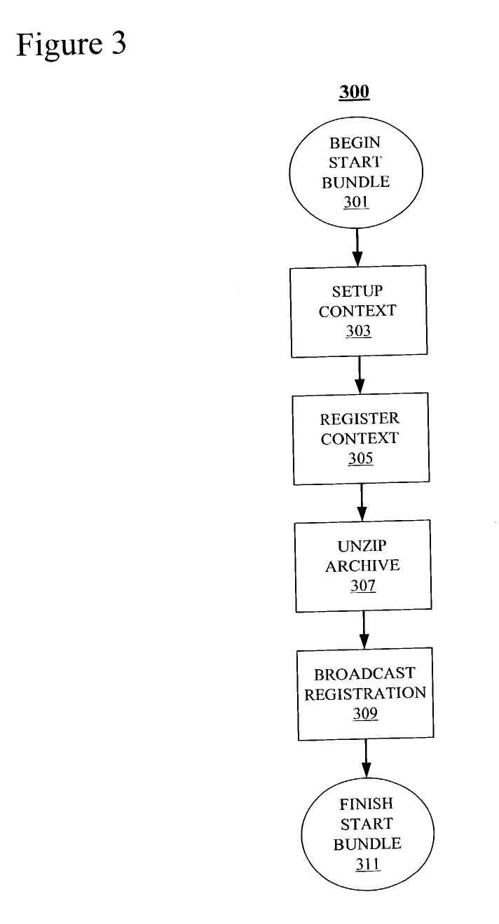

A third section 205 of class 115 includes functions, or, in object oriented terminology, “methods,” of class 115, i.e. a “Start” method 221, an “ExtractJAR” method 223, a “Stop” method 225, and a “Delete” method 227. Start and Stop methods 221 and 225 each have an argument of type BundleContext, described above. ExtractJAR method 223 is called without arguments and Delete method 227 has an argument of type string. Start, ExtractJAR, and Stop methods 221, 223 and 225 are described in more detail in conjunction with FIGS. 3-5, respectively.

FIG. 3 is a flow chart of a process 300 corresponding to Start method 221 in OSGiInstallBundle class 115 of FIGS. 1 and 2. Process 300 begins in a “Begin Start Bundle” step 301 and control proceeds immediately to a “Setup Context” step 303 in which class 115 allocates resources that bundle 111 (FIG. 1) needs. Control then proceeds to a “Register Context” step 305 in which bundle 111 is registered with the framework 107 based upon class 115 as referenced in thisClazz variable 219 (FIG. 2).

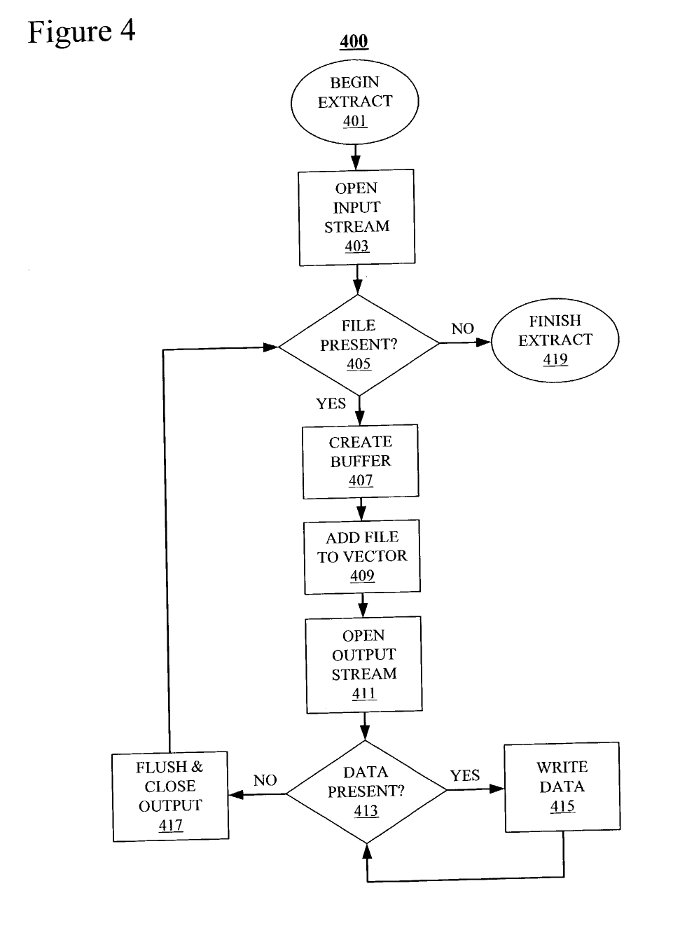

Registration of bundle 111 with the framework 107 enables OSGi bundle 109, as well as any other bundle not shown, to benefit from the services and resources of the framework 107, as described above in conjunction with be variable 207 of FIG. 2. Once bundle 111 is registered, information needed for bundle's 111 internal use is stored in bc variable 207. From step 305, control proceeds to an “Unzip Archive” step 307, which is described in detail below in conjunction with FIG. 4. Control then proceeds to a “Broadcast Registration” step 309 in which start method 221 notifies installed, OSGi bundles such as bundle 109 that the services and resources of bundle 111 are available. In the alternative, installed, OSGi bundle 109 can register an OSGi “listener” with OSGi framework 107 so that framework 107 notifies bundle 109 when bundle 111 and its non-OSGi resources 113 (FIG. 1) are registered. Control then proceeds to a “Finish Start Bundle” step 311 in which Start method 221 is complete.

FIG. 4 is a flow chart of a process 400 corresponding to ExtractJAR method 223 in OSGIInstallBundle class 115 of FIGS. 1 and 2 and Unzip Archive step 307 of FIG. 3. Process 400 begins in a “Begin Extract” step 401 and control proceeds immediately to an “Open Input Stream” step 403 in which process 400 opens a buffered input stream corresponding to a zip file referenced by zipFileName variable 213 (FIG. 2). Process 400 then proceeds to a “File Present?” step 405 in which process 400 determines whether or not a file is present on the input stream opened in step 403. Of course, the first time through the loop a file is typically present. If no file is present, typically once all files have been extracted, control proceeds to a “Finish Extract” step 419 in which process 400 is complete.

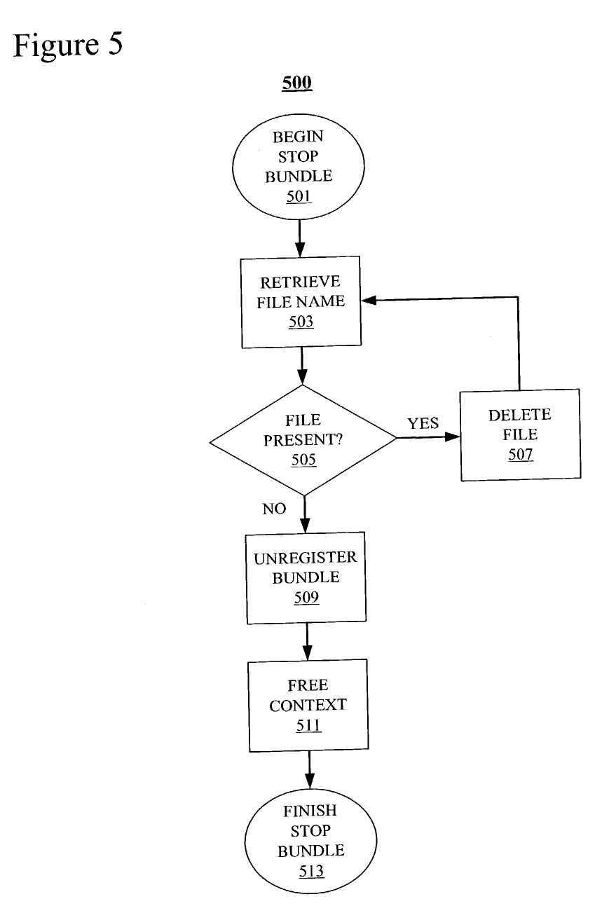

If, in step 405, process 400 determines that a file is present, then control proceeds to a “Create Buffer” step 407 in which a memory buffer is created in which to store a number of bytes of data, the number of bytes being equal to the integer stored in BUFFER variable 209 (FIG. 2). Control then proceeds to an “Add File to Vector” step 409 in which the name of the file determined to be present in step 405 is given a fully qualified name by appending the name of the file to a target directory name stored in targetDirectoryName variable 211 (FIG. 2). The fully qualified file name is then stored in fileNamesInZip variable 215 (FIG. 2). Delete method 227 (FIG. 2) of OSGiInstallBundle class 115 uses the file names stored in fileNamesinZip variable 215 to remove the files from the system 100 (Fig. 1) during execution of Stop method 225 (FIG. 2), which is described below in conjunction with FIG. 5.

Once the fully qualified name of the file detected in step 405 is added to vector variable 215 in step 409, control proceeds to an “Open Output Stream” step 411 in which a buffered output stream is opened. The buffered output stream corresponds to the fully qualified file name stored in step 409. Control then proceeds to a “Data Present?” step 413 in which process 400 determines whether or not data is present at the specified file name. If not, control proceeds to a “Flush and Close Output” step 417 in which the buffered output stream opened in step 411 is flushed and closed. Control then returns to File Present? step 405 in which processing continues as described above.

If, in step 413, process 400 determines that data is present, then control proceeds to a “Write Data” step 415 in which the detected data is written to the output stream opened in step 411. Once a number of bytes equal to the number stored in BUFFER variable 209 has been written or an end of file signal is detected, then control returns to step 413 in which processing continues as described above. In other words, if there is no more data to be written in the current file, control proceeds to step 417 and then 405. If there are no more files to be written in step 405, then control proceeds to Finish Extract step 419 in which process 400 is complete.

FIG. 5 is a flow chart of a process 500 corresponding to Stop method 225 in OSGiInstalBundle class 115 of FIGS. 1 and 2. Process 500 begins in a “Begin Stop Bundle” step 501 and control proceeds immediately to a “Retrieve File Name” step 503 in which a fully qualified file name stored in fileNamesInZip variable 215 (FIG. 2) is retrieved. The vector of files stored in variable 215 are retrieved one at a time. If there is a file name to retrieve, control proceeds to a “Delete File” step 507 in which the file corresponding to the file name retrieved in step 503 is deleted from system 100 (FIG. 1). Step 507 corresponds to Delete method 227 of ASGiInstallBundle class 115. Process 500 then returns to step 503 in which the next name in the list is retrieved.

If in step 505, process 400 determines that there are no more files to retrieve, then control proceeds to an “Unregister Bundle” step 509 in which bundle 111 is removed from the registry of the OSGi framework 107. Process 500 then continues to a “Free Context” step 511 in which the memory associated with bc variable 207 is released. Control then proceeds to a “Finish Stop Bundle” step 513 in which process 500 is complete.

In one alternative, prior to completion of process 500 in step 513, stop method 225 notifies other, installed bundles such as bundle 109 that bundle 111 has been uninstalled and, therefore, its services and non-OSGi resources 113 (FIG. 1) are no longer available. In the alternative, the OSGi listener described above in conjunction with FIG. 3 may notify only those bundles that have requested information on the status of bundle 111.

While the invention has been shown and described with reference to particular embodiments thereof, it will be understood by those skilled in the art that the foregoing and other changes in form and detail may be made therein without departing from the spirit and scope of the invention, including but not limited to additional, less or modified steps performed in the same or a different order.

The following is an exemplary computer listing the illustrates an embodiment of the claimed subject matter, specifically an example of the OSGiInstallBundle class 115 of FIGS. 1 and 2:

```
package com.ibm.osg.service;
    import org.osgi.framework.*;
    import java.io.*;
    import java.util.*;
    import java.util.zip.*;
    public class OSGiInstallBundle implements BundleActivator {
      private BundleContext bc;
      private static final int BUFFER = 2048;
      private String targetDirectoryName = “<replace with the target directory on
    the file system>”;
      private String zipFilename = “<replace with the ZIP archive file name>”;
      private Vector filenamesInZip = new Vector( );
      protected ServiceRegistration registration;
      protected static String thisClazz =
    “com.ibm.osg.service.OSGiInstallBundle”;
      public OSGiInstallBundle( ) {
        // constructor( )
      }
      public void start(BundleContext bc) {
        this.bc = bc;
        registration = bc.registerService(thisClazz, this, null);
        extractJar( );
      }
      public void stop(BundleContext bc) {
        Enumeration enum = filenamesInZip.elements( );
        while ( enum.hasMoreElements( ) ) {
          String fileToDelete = (String)enum.nextElement( );
          delete(fileToDelete);
        }
    registration.unregister( );
    this.bc = null;
    }
    private void delete(String fileName) {
      File myFile = new File(fileName);
      boolean retval = myFile.delete( );
      if ( retval == false ) {
          System.out.println(“ERROR deleting: ”+ fileName);
    }
  }
    private void extractJar( ) {
      try {
        BufferedOutputStream dest = null;
        InputStream fis = getClass( ).getResourceAsStream(zipFilename);
        ZipInputStream zis = new ZipInputStream(new
  BufferedInputStream(fis));
        ZipEntry entry;
        while ( (entry = zis.getNextEntry( )) != null ) {
          int count;
          byte data[] = new byte[BUFFER];
          FileOutputStream fos = new FileOutputStream(targetDirectoryName +
  entry.getName( ));
          filenamesInZip.addElement(targetDirectoryName + entry.getName( ));
          dest = new BufferedOutputStream(fos, BUFFER);
          while ( (count = zis.read(data, 0, BUFFER)) != −1 ) {
            dest.write(data, 0, count);
          }
          dest.flush( );
          dest.close( );
        }
        zis.close( );
      } catch ( Exception e ) {
        e.printStackTrace( );
      }
    }
  }
```

We claim:

1. A method for delivering non-OSGi compliant resources in an OSGi framework, comprising the steps of:
defining a Java class for registering a non-OSGi compliant bundle within an OSGi framework;
storeing one or more resources in memory; and
executing a start function of the Java class, the start function comprising the steps of:
registering an instantiation of the Java class with the OSGi framework; and
extracting the one or more resources from the memory into a target directory.

2. The method of claim 1, further comprising the step of:
broadcasting to bundles registered with the OSGi framework information corresponding to the non-OSGi compliant bundle.

3. The method of claim 1, further comprising the steps of:
registering, by a second bundle, a listener with the OSGi framework; and
transmitting to the second bundle, via the listener, information corresponding to the non-OSGi complaint bundle.

4. The method of claim 1, the extraction of the one or more resources comprising the steps of:
opening an input stream corresponding to the one or more resources;
detecting whether or not a resource of the one or more resources is present on the opened input stream; and, if a resource is present, extracting the detected resource, comprising the steps of:
opening an output stream;
detecting whether or not data is present on the opened input stream; and, if data is present;
writing the detected data to output stream; and
returning to the detecting whether or not a resource is present step to determine whether or not another resource of the one or more resources is present.

5. The method of claim 1, further comprising the steps of:
associating each resource of the one or more resources with a vector variable;
unregistering the non-OSGi compliant bundle from the framework; and
deleting the extracted one or more resources from the target directory based upon the vector variable.

6. The method of claim 5, further comprising the step of:
broadcasting to bundles installed in the framework information corresponding to the unregistration of the non-OSGi compliant bundle.

7. The method of claim 1, wherein the one or more resources include a text file.

8. The method of claim 1, wherein the one or more resources include an executable file.

9. The method of claim 1, wherein the one or more resources are located on a server computer and the target directory is located on a client computer.

10. The method of claim 1, wherein the one or more resources are stored in a Java archive (JAR) file format.

11. A computer program product for delivering non-OSGi compliant resources in an OSGi framework, comprising:
a Java class, stored on a recording medium, for registering a non-OSGi compliant bundle with an OSGi framework;
means, stored on a recording medium, for storing one or more resources in a memory; and
means, stored on the recording medium, for executing a start function of the Java class, the start function comprising:
means, stored on the recording medium, for registering an instantiation of the Java class with the OSGi framework; and
means, stored on the recording medium, for extracting the one or more resources from the memory into a target directory.

12. The computer program product of claim 11, further comprising:
means, stored on the recording medium, for broadcasting to bundles registered with the OSGi framework information corresponding to the non-OSGi compliant bundle.

13. The computer program product of claim 11, further comprising:
means, stored on the recording medium, for registering, by a second bundle, a listener with the OSGi framework; and
means, stored on the recording medium, for transmitting to the second bundle, via the listener, information corresponding to the non-OSGi complaint bundle.

14. The computer program product of claim 11, the means for extracting of the one or more resources comprising:
means, stored on the recording medium, for opening an input stream corresponding to the one or more resources;
means, stored on the recording medium, for detecting whether or not a resource of the one or more resources is present on the opened input stream; and, if a resource is present, extracting the detected resource, comprising:
means, stored on the recording medium, for opening an output stream;
means, stored on the recording medium, for detecting whether or not data is present on the opened input stream; and, if data is present;
means, stored on the recording medium, for writing the detected data to output stream; and
means, stored on the recording medium, for returning to the detecting means.

15. The computer program product of claim 11, further comprising:
means, recorded on the recording medium, for associating each resource of the one or more resources with a vector variable;
means, stored on the recording medium, for unregistering the non-OSGi compliant bundle from the framework; and
means, stored on the recording medium, for deleting the extracted one or more resources from the target directory based upon the vector variable.

16. The computer program product of claim 15, further comprising:
means, stored on the recording medium, for broadcasting to bundles installed in the framework information corresponding to the unregistration of the non-OSGi compliant bundle.

17. The computer program product of claim 11, wherein the one or more resources include a text file.

18. The computer program product of claim 11, wherein the one or more resources include an executable file.

19. The computer program product of claim 11, wherein the one or more resources are located on a server computer and the target directory is located on a client computer.

20. The computer program product of claim 11, wherein the one or more resources are stored in a Java archive (JAR) file format.

21. A object-oriented programming class for delivering non-OSGi compliant resources in an OSGi framework, comprising:
start function logic, the start function logic comprising:
logic for registering an instantiation of the object-oriented programming class with the OSGi framework; and
logic for extracting one or more resources stored in a memory from the memory into a target directory.

22. The object-oriented programming class of claim 21, the start function logic further comprising:
logic for broadcasting to one or more bundles registered with the OSGi framework information corresponding to the instatiation of the object-oriented class.

23. The object-oriented programming class of claim 21, further comprising:
logic for registering, by a second bundle, a listener with the OSGi framework; and
logic for transmitting to the second bundle, via the listener, information corresponding to the instatiation of the object-oriented class.

24. The object-oriented programming class of claim 21, the logic for extraction of the one or more resources comprising:
logic for opening an input stream corresponding to the one or more resources;
logic for detecting whether or not a resource of the one or more resources is present on the opened input stream; and, if a resource is present, extracting the detected resource, comprising:
logic for opening an output stream;
logic for detecting whether or not data is present on the opened input stream;
logic for writing the detected data to output stream; and
logic for return to the logic for detecting whether or not a resource is present.

25. The object-oriented programming class of claim 21, further comprising a stop function, the stop function comprising:
logic for unregistering the instatiation of the object-oriented class from the OSGi framework; and
logic for deleting the extracted one or more resources from the target directory based upon a vector variable; and,
the start function further comprising:
logic for associating each resource of the one or more resources with the vector variable.

26. The object-oriented programming class of claim 25, further comprising:
logic for broadcasting to bundles installed in the framework information corresponding to the unregistration of the instantiation of the object-oriented class.

27. The object-oriented programming class of claim 21, wherein the one or more resources include a text file.

28. The object-oriented programming class of claim 21, wherein the one or more resources include an executable file.

29. The object-oriented programming class of claim 21, wherein the one or more resources are located on a server computer and the target directory is located on a client computer.

30. The object-oriented programming class of claim 21, wherein the one or more resources are stored in a Java archive (JAR) file format.
